(19) United States
(12) Patent Application Publication
(10) Pub. No.: US 2025/0247773 A1
(43) Pub. Date: Jul. 31, 2025

(54) ENHANCED SCAN FOR ACCESS POINT

(71) Applicant: HEWLETT PACKARD ENTERPRISE DEVELOPMENT LP, Spring, TX (US)

(72) Inventors: Zhenlei Wang, Beijing (CN); Jianpo Han, Beijing (CN); Yu Jun, Beijing (CN)

(21) Appl. No.: 18/428,492

(22) Filed: Jan. 31, 2024

(51) Int. Cl. H04W 48/16

(52) U.S. Cl. CPC H04W 48/16

(57) ABSTRACT

In implementations of the present disclosure, there is provided an approach for performing scanning operations on a channel. A method comprises receiving a request for scanning on a second channel different from the first channel. Moreover, a first duration for the scanning of the second channel is determined based on the request. Then, a second duration for preventing a station from sending a packet to the AP on the first channel is determined based on the first duration. Thus, a beacon frame or a probe response frame including a quiet element or a traffic identifier (TID)-to-link mapping element may be generated based on the second duration. The beacon frame or the probe response frame is then transmitted to the station. Implementations of the present disclosure can avoid the packet loss on the working channel when the AP scans on the foreign channels, and improve the service quality.

### BACKGROUND

In order to identify available channels for network communications, an access point (AP) may perform channel scan operations. During the scanning, the AP sequentially scans each of the available channels in the frequency range, and assesses signal strength and interference levels on each channel. By scanning the available channels, the access point may identify the optimal channel with the lowest level of interference and the strongest signal strength. This ensures that the access point can establish a robust and reliable connection with stations, delivering high-quality network services.

With regularly scanning channels, the access point may determine the optimal channel of the available channels. Therefore, the AP may switch the current working channel to the optimal channel if necessary to maintain consistent network performances. Thus, channel scanning is essential for improving the reliability, performance, and efficiency of wireless communications, which collectively contribute to providing a better overall user experience for users.

### BRIEF DESCRIPTION OF THE DRAWINGS

Implementations of the present disclosure may be understood from the following Detailed Description when read with the accompanying figures. In accordance with the standard practice in the industry, various features are not drawn to scale. In fact, the dimensions of the various features may be arbitrarily increased or reduced for clarity of discussion. Some examples of the present disclosure are described with respect to the following figures.

FIG. 1 illustrates a block diagram of an example environment in which reference implementations of the present disclosure may be implemented;

FIG. 2 illustrates an example of a quiet element format according to implementations of the present disclosure;

FIG. 3 illustrates an example of transmitting a beacon frame or a probe response frame, including a quiet element according to implementations of the present disclosure;

FIG. 4 illustrates another example of transmitting a beacon frame or a probe response frame, including a quiet element according to implementations of the present disclosure;

FIG. 5 illustrates an example of a traffic identifier (TID)-to-link mapping element format according to implementations of the present disclosure;

FIG. 6 illustrates an example of transmitting a beacon frame or a probe response frame, including a TID-to-link mapping element according to implementations of the present disclosure;

FIG. 7 illustrates a flow chart of an example method for transmitting the beacon frame or the probe response frame according to implementations of the present disclosure; and

FIG. 8 illustrates an example access point device according to implementations of the present disclosure.

### DETAILED DESCRIPTION

As discussed above, the AP may scan channels to improve the reliability, performance, and efficiency of wireless communications. Therefore, the scan is a key feature of APs. When an AP works on a working channel, it may perform opportunistic scans for foreign channels so that it may determine the optimal channel to provide good access services. In order to avoid beacon loss during a scan operation, a beacon delay scan is used by the AP. In this case, the AP is prevented from sending the packets to the stations via the working channel when the AP scans in foreign channels to avoid packet loss in a transmit direction.

However, in a receive direction of the AP, packets that are sent by the stations to the AP cannot be controlled. If the stations send uplink packets to the AP during the scan operation, the UL packets will be lost when the AP scans on foreign channels. In this case, the AP cannot receive complete data. This may cause errors in applications and lead to a significant decrease in service quality.

Therefore, implementations of the present disclosure propose a solution for preventing a station from sending packets to the AP when the AP scans on foreign channels. According to implementations of the present disclosure, the AP communicates with stations via a first channel, and may receive a request for scanning on a second channel different from the first channel from a controller. After the AP receives the request for scanning, it will determine a first duration for the scanning of the second channel based on the request. The determined first duration may be used to determine a second duration for preventing a station from sending a packet to the AP on the first channel. Then, the AP uses the second duration to fill a quiet element or a TID-to-link mapping element to generate a beacon frame or a probe response frame. At last, the AP transmits the beacon frame or the probe response frame with the quiet element or the TID-to-link mapping element to the station.

As discussed above, the AP may transmit the beacon frame or the probe response frame containing the quiet element or the TID-to-link mapping element to the stations via the first channel between the AP and the stations. The stations may receive the beacon frame or the probe response frame and obtain the information in the quiet element or the TID-to-link mapping element. Then, the stations may avoid sending packets to the AP during the second duration obtained from the quiet element or the TID-to-link mapping element. Therefore, when the AP scans on the second channel, the stations would not transmit packets to the AP on the first channel. In this case, the packets from the stations to the AP will not be lost when the AP scans on the foreign channels. This may avoid errors in applications and improve service quality.

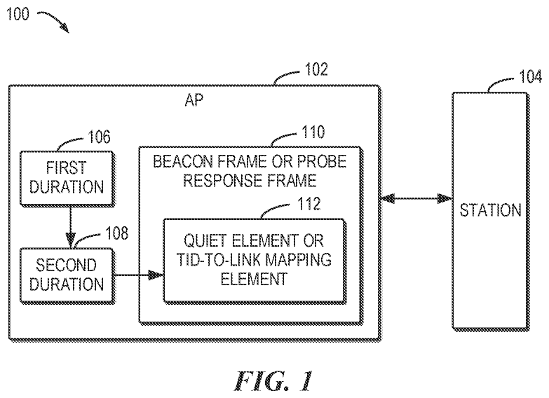

Other advantages of implementations of the present disclosure will be described with reference to the reference implementation as described below. Reference is made below to FIG. 1 through FIG. 8 to illustrate basic principles and several reference implementations of the present disclosure herein.

FIG. 1 shows a block diagram of an example environment in which reference implementations of the present disclosure may be implemented. In the example environment 100 of FIG. 1, an AP 102 may communicate with a station 104. FIG. 1 shows one station communicating with the AP, which is only an example rather than the limitation of the present disclosure. In some implementations, the AP 102 communicates with a plurality of stations.

In some implementations, the AP 102 may not be a multi-link device (MLD). The AP communicates with the station via one link. Therefore, a channel on the link is used to communicate packets between the AP and the station. In some implementations, the AP 102 is an AP MLD, which may communicate with the station via two or more links. Therefore, a channel on each link of the two or more links is used to communicate packets between the AP and the station. The used channel on the link may be referred to as a first channel.

The AP 102 may work on the first channel in a link. The AP 102 may receive a scan request, which causes the AP 102 to scan on a foreign channel in the link. The foreign channel may be referred to as a second channel, and the above first channel and the second channel are on the same link. After receiving the scan request, the AP may prepare to scan in the second channel. In order to avoid the station 104 sending packets over the first channel during the scanning, the AP will transmit a beacon frame or a probe response frame 110 to notify the station of the scanning.

In order to generate the beacon frame or a probe response frame 110, the AP first determines a first duration for the scanning of the second channel. In some implementations, the duration that the AP scans on the second channel is a predetermined duration, for example, 50 ms. Therefore, the first duration may be set as the predetermined duration. In some implementations, the duration that the AP scans on the second channel is determined based on the parameters or the configurations of the AP. Therefore, the first duration is determined based on the parameters or the configurations of the AP.

After the first duration 106 is determined, the AP may further determine the second duration 108 to prevent a station from sending a packet to the AP on the first channel based on the first duration. In order to notify the station, the second duration 108 is used to fill a quiet element or a TID-to-link mapping element 112 in the beacon frame or probe response frame 110.

In some implementations, the quiet element is used in the beacon frame or the probe response frame. The quiet element contains a plurality of fields, for example, a quiet duration field. The determined second duration is used to fill the quiet duration field. The AP may obtain other information about the scanning and fill the other information into the other field of the quiet element. Then, when the quiet element in the beacon frame and probe response frame is advertised to the station on the first channel, the station will obtain the information about the scanning from the quiet element in the beacon frame and probe response frame, and will not send the packets to the AP on the first channel during the scanning period.

In some implementations, the quiet element may be used in a non-Wi-Fi MLD scenario. Therefore, the AP may transmit the beacon frame or the probe response frame, including the quiet element, via the first channel on one link. In some implementations, the quiet element may be used in a Wi-Fi MLD scenario. The AP MLD may transmit the beacon frames or the probe response frames, including the quiet element, via two or more channels on two or more links. Additionally, the quiet element in the beacon frame or the probe response frame on each link may be set as the same content.

In some implementations, the TID-to-link mapping element is used in the beacon frame or the probe response frame. The TID-to-link mapping element contains a plurality of fields, for example, an expected duration field. As described above, the AP may determine the second duration for preventing a station from sending a packet to the AP on the first channel. Then, the AP may fill the expected duration field based on the second duration. The second duration is determined based on the first duration. In order to avoid the station sending packs on the first channel, the second duration is longer than the first duration. The second duration may contain the first duration and the witching duration from the first channel to the second channel. The AP may obtain other information about the scan and fill the other information into the other field of the TID-to-link mapping element. Then, the TID-to-link in the beacon frame and probe response frame is advertised to the station on the first channel. The station will obtain the information about the scanning from the TID-to-link in the beacon frame and probe response frame, and would not send the packets to the AP on the first channel during the scanning period.

Additionally, the TID-to-link mapping element may be used in the Wi-Fi MLD scenario. The AP MLD may transmit the beacon frames or the probe response frames, including the quiet elements, via two or more channels on two or more links. For the link that the AP performs the scan operation, the TID-to-link mapping element in beacon frame or the probe response frame is set based on the second duration and other information about the scan operation. For other links, the TID-to-link mapping elements in beacon frame or the probe response frames are set with reference to the quiet element in the link that the AP performs the scanning operation. Therefore, for Wi-Fi MLD, AP MLD may use the TID-to-link mapping element to disable the link, which will perform a scanning operation; non-AP MLDs won't send packets on the disabled link to avoid packet loss when the AP scans on the second channel or a foreign channel.

The AP 102 may transmit the beacon frame or the probe response frame 110 to the station 104. The station 104 may receive the beacon frame or the probe response frame 110 and obtain the information in the quiet element or the TID-to-link mapping element of the beacon frame or the probe response frame. Therefore, the station 104 may determine the second duration for preventing sending a packet to the AP on the first channel. When the AP 102 performs the scanning operation on the second channel at the second duration, the station will not send packets on the first channel. Therefore, the packets sent from the station will not be lost.

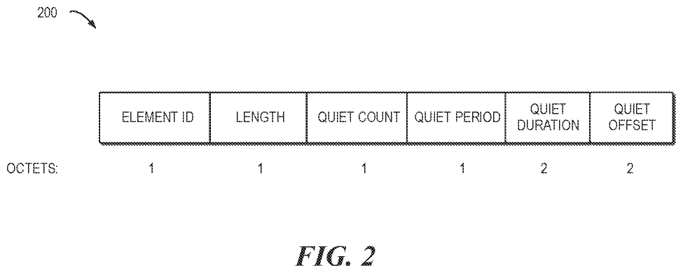

FIG. 2 shows an example 200 of a quiet element format according to implementations of the present disclosure. The quiet element was originally used to make the entire network silent for a period, in order to detect whether there were radar signals around. In this disclosure, the use of the quiet element is changed. The quiet element is used to quiet stations connected to the AP via the first channel when the AP scans on the second channel or the foreign channel. In this way, the station does not send packets when the AP scans on the second channel or the foreign channel, and packet loss won't occur.

For the non-Wi-Fi MLD scenario, the Quiet element may be set according to the scanning. As shown in FIG. 2, an element identifier (ID) identifies the quiet element. The length field indicates the length of the following fields. The quiet count field is set to the number of target beacon transmission time (TBTT) intervals until the beacon interval during which the next quiet interval starts. The value of 0 is reserved for the quiet count field. In some implementations, the quiet count field may be set to 1. This means that the scanning operation will be performed after one TBTT interval. In some implementations, the quiet count field may be set to any suitable value.

Further, the quiet period field may be set to 0, which indicates that no periodic quiet interval is defined. If the quiet period field is set to 1, the periodic quiet interval is defined. The Quiet Offset field is set to the duration of AP channel switching in time units (Tus). The Quiet Duration field is set to the second duration, which is the dwell time when scanning on foreign channel. Therefore, stations may be silent during the AP scanning to prevent uplink packets loss.

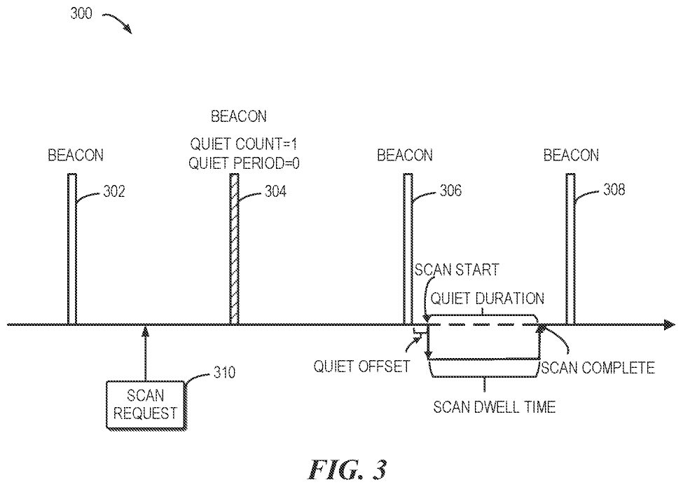

FIG. 3 shows example 300 of transmitting a beacon frame or a probe response frame, including a quiet element, according to implementations of the present disclosure. As shown in FIG. 3, the AP and the station work on the non-WIFI MLD scenario. Therefore, one link is used between the AP and the stations. The beacon frames 302, 306, and 308 are the normal beacon frames, and the beacon frame 304 is a beacon frame containing the quiet element. The scan request 310 is received by the AP at a time point. Then, the beacon frame 304 with the quiet element is generated and transmitted to the station at the next TBTT adjacent to the time point.

As shown in FIG. 3, the quiet count in the quiet element is set to 1 and the quiet period in the quiet element is set to 0. Therefore, the AP will perform the scan after one TBTT interval is passed and no period quiet interval is defined. Then, the AP performs a switching operation from the first channel to the second channel after the one TBTT interval is passed. In FIG. 3, the quiet offset is a switching duration from the first channel to the second channel. After the AP switches to the second channel, it will scan in the second channel during the scan dwell time. The quiet offset and the quiet duration are also filled in the quiet element. Therefore, the quiet element contains the time information about the scanning. When the station receives the beacon frame containing the quiet element, the station will determine the quiet duration, the time points when the scan starts and the scan completes based on the information in the quiet element in the beacon frame. When the AP scans on the second channel or a foreign channel, the station will not send packets to the AP to avoid the packet loss.

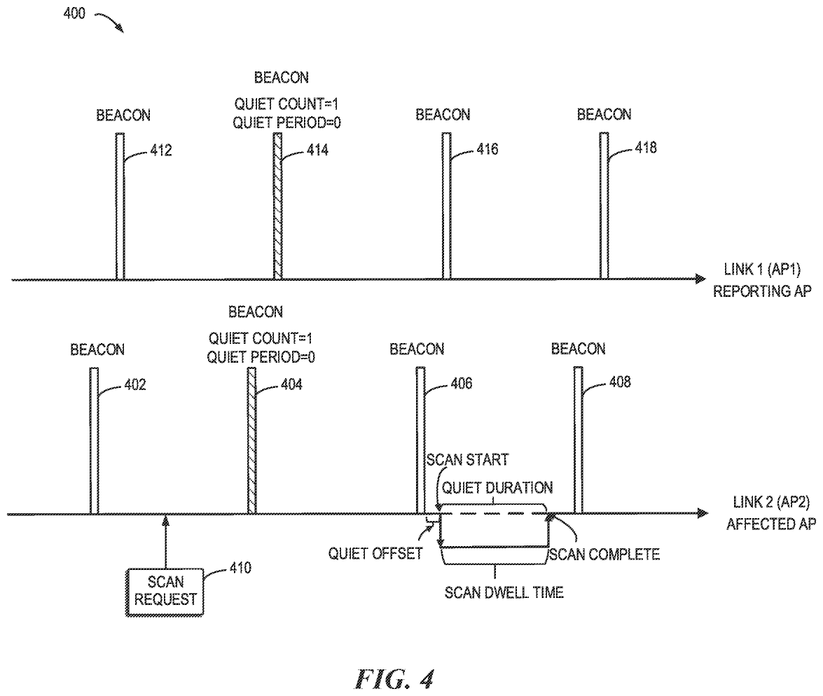

The quiet element may also be applied to Wi-Fi MLD scenario. FIG. 4 shows another example 400 of transmitting a beacon frame or a probe response frame, including a quiet element according to implementations of the present disclosure. In FIG. 4, AP 1 and AP 2 are two APs affiliated with an AP MLD that operate on a link 1 and a link 2, respectively. In each of the link 1 and the link 2, there is a working channel over which the AP 1 or AP2 communicates with stations.

As shown in FIG. 4, the AP MLD will perform the scan operation on the second link. The working channel in the second link is referred to as the first channel. When the AP2 of the AP MLD receives the scan request 410 for the link 2. The information about the scan will be included in the quiet element of the beacon frame. The quiet element in the beacon frame on the second link may be configured based on the scan parameters. The values of the quiet count field, the quiet offset field, the quiet period field, and the quiet duration field of the quiet element carried on Link 2 follow the same rules in non-Wi-Fi 7 MLD scenario. In FIG. 4, there are three beacon frames 402, 406, and 408, which are the normal beacon frames, and one beacon frame 404 having the quiet element in the link 2. For example, the quiet count field in the quiet element is set to 1, the quiet period field in the quiet element is set to 0. The AP 2 will perform the scan operation between the beacon frame 406 and the beacon frame 408. The quiet offset and the quiet duration can be determined by the AP2 and the quiet offset and the quiet duration can be used to fill the quiet element in the beacon frame. Therefore, the stations connected to the AP2 via the link 2 will receive the beacon frame with the quiet element and do not send the packets when the AP2 performs the scan operation.

In the Wi-Fi MLD scenario, the AP MLD may have other links which are used to report the scan operation in the second link. For example, in FIG. 4, there is the link 1, which reports the scan operation. In the link 1, the beacon frames 412, 416, and 418 are the normal beacon frames and the beacon frame 414 is the beacon frame with the quiet element. AP 1, as the reporting AP, includes a quiet element in the per-station profile sub element corresponding to AP2 in the basic multi-link element carried in its beacon frame and probe response frames. These values carried on the quiet element in the Link 1 are set with reference to the quiet element in the Link 2.

In some implementations, the TID-to-link mapping element may be used to notify the stations of the scanning operation. The TID-to-link mapping element is used in the Wi-Fi MLD scenario. The TID-to-link mapping element is originally used to indicate which links can be used to data transmission of specific TIDs. In complex communication networks, this mapping element can help manage and control the transmission path of data packets, ensuring that data can be efficiently and accurately transmitted to the target link.

In this disclosure, the TID-to-link mapping element in beacon frames or probe Response frames may be used to disable a link temporarily for Wi-Fi MLD. For the AP MLD, when one of the links performs scanning, the link may be temporarily disabled by advertising the TID-to-link mapping element in the beacon frames and the probe response frames in all links. During this process, all TIDs are mapped to non-scanning links, and no TIDs are mapped to the scanning link. Therefore, the scanning link is disabled. In this way, the non-AP MLD won't have packet transmission on the scanning link. This prevents packet loss during the scan.

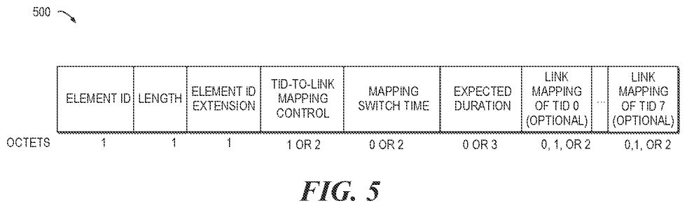

FIG. 5 illustrates an example of a TID-to-link mapping element format according to implementations of the present disclosure. In the example 500, the mapping switch time field has one or two octets and has units of Tus. The mapping switch time field is set to the time at which the new mapping is established using as a time base the value of the timing synchronization function (TSF) corresponding to the basic service set (BSS) identified by the basic service set identifier (BSSID) of the frame containing the TID-to-link Mapping element.

As shown in FIG. 5, the expected duration field has one or two octets. The expected duration field may indicate the duration for which the proposed TID-to-link mapping is expected to be effective in units of TUs when the mapping switch time field is present, and the remaining duration for which the proposed TID-to-link mapping is expected to be effective in units of TUs when the mapping switch time field is not present. The link mapping of TID fields is used to indicate that the traffic with the TIDs will be mapped to which links. For example, there are two links between the AP MLD and a non-AP MLD, such as a first link and a second link. The second link of the two links will be used to perform the scan operation on the foreign channel. In this case, all link mapping of TID fields in TID-to-link mapping element may be set to the first link. Therefore, the traffics between the AP MLD and the non-AP MLD will be transferred to the first link and the AP MLD and the non-AP MLD will not send packets on the second link.

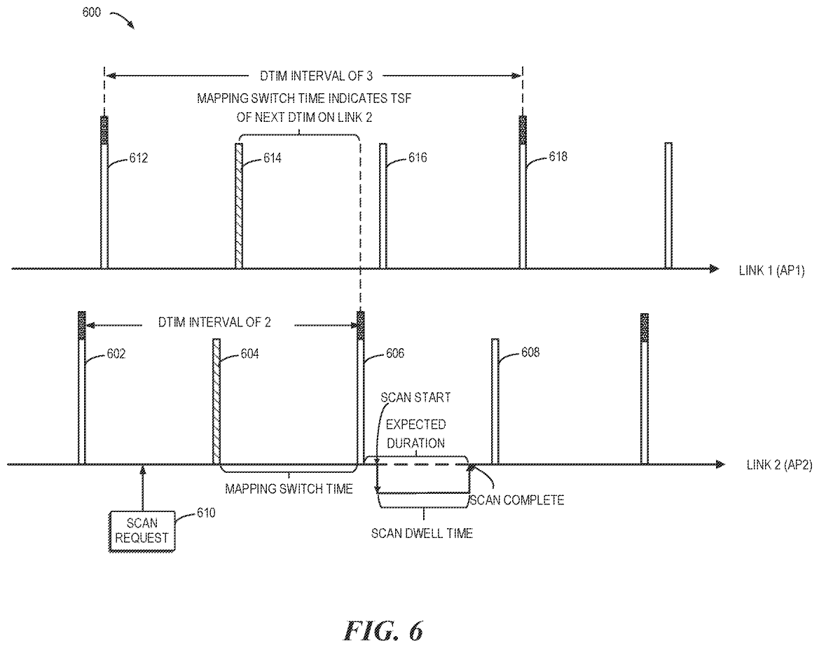

FIG. 6 shows an example of transmitting a beacon frame or a probe response frame, including a TID-to-link mapping element, according to implementations of the present disclosure. In the example 600, there are two links between the AP MLD and the non-AP MLD or the stations. AP2 will perform the scan operation on the link 2. The scan request 610 for scanning on a second channel in the link 2 is received at a time point. The next beacon frame adjacent the time point is used to carry the TID-to-link mapping element. As shown in FIG. 6, on the link 2, there are a beacon frame 604 with the TID-to-link mapping element, three delivery traffic indication map (DTIM) beacon frames, for example a DTIM beacon frame 602 and a DTIM beacon frames 606, and a normal beacon frame 608. In this link 2, the DTIM interval between two DTIM beacon frames is 2. The mapping switch time is determined by the AP MLD and indicates the TSF of the next DTIM on the link 2. For example, the mapping switch time may be an interval between the beacon with the TID-to-link mapping element and the next adjacent DTIM beacon frame. In some implementations, the mapping switch time is a TBTT interval. In some implementations, the mapping switch time may be multiple TBTT intervals. The mapping switch time is used to fill the mapping switch time field in the TID-to-link mapping element. Moreover, the expected duration field is filled with a duration that is set from the start of DTIM beacon frame to the end of the scan operation. In addition, all link mapping of TID fields in the TID-to-link mapping element is not link 2, and none of TID is mapped to link 2. Then, the AP 2 advertises the TID-to-link mapping element in the beacon frame or the probe response frames on the link 2.

Moreover, in the MLD scenario, the link 1 is also used to advertise the TID-to-link mapping element in the beacon frame. As shown in the FIG. 6, on the link 1, there are two normal beacon frames, such as a beacon frame 616, and two DTIM beacon frames, for example, a DTIM beacon frame 612 and a DTIM beacon frame 618. In this link 1, the DTIM interval between two DTIM beacon frames is 3. The TID-to-link mapping element in the beacon frame on the link 1 is configured with reference to the TID-to-link mapping element in the beacon frame on the link 2. The values of the expected duration fields in the TID-to-link mapping elements may be the same. However, the mapping switch time indicates the TSF of next DTIM on the link 2. Therefore, the value in the mapping switch time field is the duration from the time point for the beacon frame 614 on the link 1 to the time point for the DTIM beacon frame 606 on the link 2. Then, the AP 1 advertises the TID-to-link mapping element in the beacon frame 614 of AP1. In addition, the TID-to-link mapping element uses all link mapping of TID fields to map all TIDs to link 1. Therefore, non-AP MLD won't have traffic on the link 2, the transmission occurs on the link 1 if have. In this case, the packets would not be lost when the AP 2 performs the scan operation in the second channel or the foreign channel.

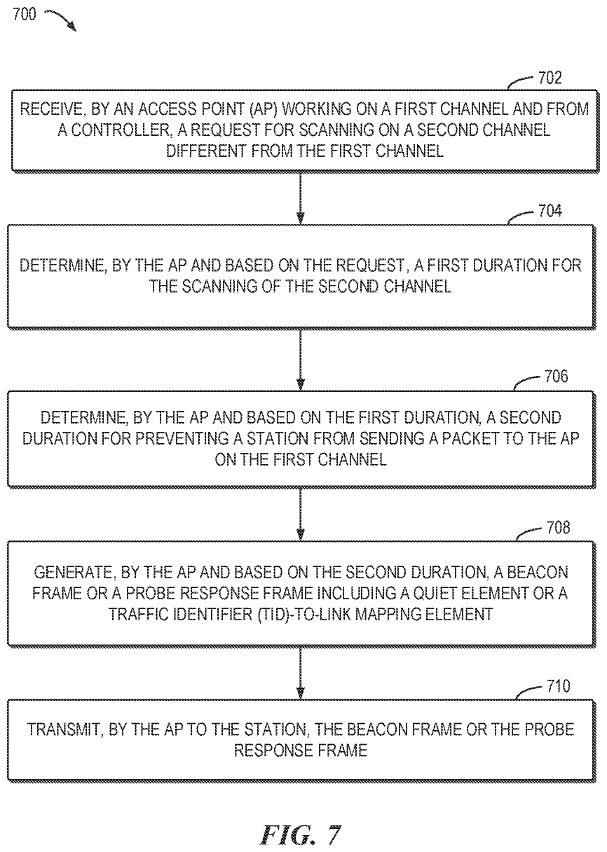

FIG. 7 illustrates a flow chart of an example method for transmitting the beacon frame or the probe response frame according to implementations of the present disclosure, and the method 700 is performed by an AP. At 702, the AP receives a request for scanning on a second channel different from the first channel from a controller. The access point (AP) works on a first channel. For example, the AP 102 receives a request for scanning on a second channel different from the first channel from a wireless access point controller. In response to receiving the request for scanning on a foreign channel, the AP will prepare to transmit the information related to the scan to the stations via a current working channel. In some implementations, the AP may be a normal AP and is not an AP MLD. In some implementations, the AP may be an AP MLD.

At 704, the AP determines, based on the request, a first duration for the scanning of the second channel. For example, the AP 102 determines the first duration 106 based on the request. The first duration is used to scan on the second channel. In some implementations, the first duration is a predetermined duration, for example, 50 ms. In some implementations, the first duration is determined by the parameters of the AP. During the first duration, the AP may scan on the second channel to detect the performance of the second channel.

At 706, the AP determines, based on the first duration, a second duration for preventing a station from sending a packet to the AP on the first channel. For example, the AP 102 determines the second duration 108 based on the first duration 106. The second duration is used to prevent a station from sending a packet to the AP on the first channel. Because the second duration corresponds to the first duration for scanning on the second channel, in order to avoid the packet loss, the stations will not send packets to the AP on the first channel. In order to notify the stations communicated with the AP via the first channel, the beacon frame or a probe response frame including a quiet element or a TID-to-link mapping element is used to inform the station about the scanning operation.

In some implementations, the quiet element in the beacon frame or a probe response frame is used to inform the station about the scanning operation. The quiet duration field in the quiet element is filled with the second duration. The quiet duration field may be read by the stations, and the stations would not send packets on the first channel during the second duration. Furthermore, the AP may further determine a number of TBTT intervals to be passed before the scanning, and determine a switching duration from the first channel to the second channel. Then, the quiet count field in the quiet element is set to the number of TBTT intervals, and the quiet offset field in the quiet element is set to the switching duration.

In some implementations, the TID-to-link mapping element in the beacon frame or a probe response frame is used to inform the station about the scanning. The second duration may be determined based on the first duration. For example, the second duration is longer than the first duration. The second duration may contain the first duration and a switching duration from the first channel to the second channel on the first link. Then, the second duration is used to fill an expected duration field in the TID-to-link mapping element. The expected duration field in the TID-to-link mapping element may be read by the stations, and the stations will not send packets on the first channel during the second duration. Furthermore, the AP may further determine a time interval to be passed before preforming a TID-to-link mapping. Then, the mapping switch time field in the TID-to-link mapping element is set to the time interval. Moreover, the AP may further fill a set of link mapping of TID fields in the TID-to-link mapping element to avoid mapping any TID to the first link. For example, each link of a set of link mapping of TID fields is set to be the other link, rather than the link that the AP performs the scan.

At 708, the AP generates, based on the second duration, a beacon frame or a probe response frame, including a quiet element or a traffic identifier (TID)-to-link mapping element. For example, the AP 102 generates the beacon frame or the probe response frame 110 with the quiet element or the TID-to-link mapping element. In some implementations, the beacon frame or a probe response frame includes a quiet element, which is filled with the second duration and other information determined by the AP 102. In some implementations, the beacon frame or a probe response frame includes the TID-to-link mapping element, which is filled with the second duration and other information determined by the AP 102.

At 710, the AP transmits to the station, the beacon frame, or the probe response frame. As an example, the AP 102 transmits the beacon frame or the probe response frame with the quiet element or the traffic identifier (TID)-to-link mapping element. After the beacon frame or the probe response frame is transmitted to the stations, the AP will perform the scanning operation at the predetermined time. The stations on the first channel will obtain the time that the scanning operation is performed by using the information in the quiet element or the TID-to-link mapping element. The station will not send packets to the AP in the first channel at the second duration.

In this way, the AP may notify the stations of the duration that the scan will be performed on the foreign channel, and the stations will not send packets at that duration. Therefore, the packets from the stations will not be lost when the AP scans on foreign channels. These operations may avoid errors in applications and improve service quality.

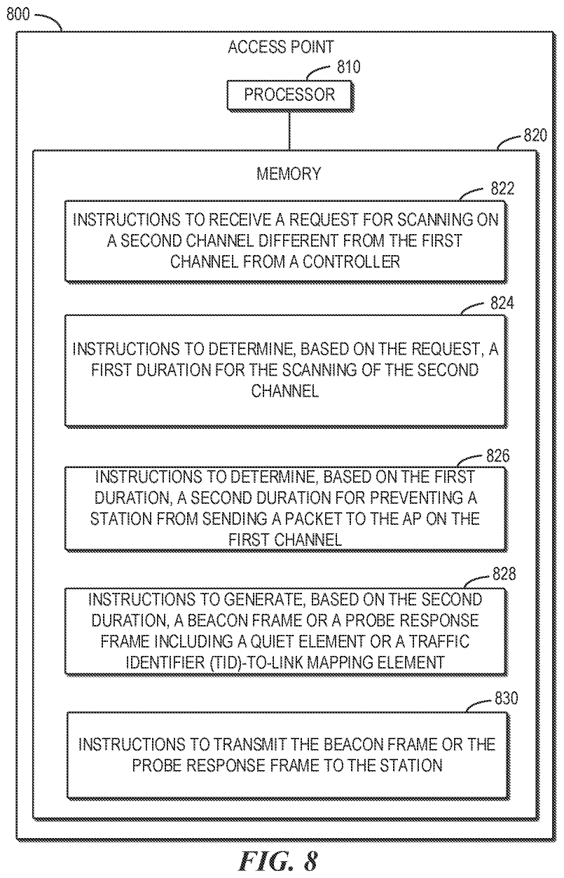

FIG. 8 illustrates an example AP MLD 800 according to implementations of the present disclosure. As shown in FIG. 8, the AP MLD 800 comprises at least one processor 810, and a memory 820 coupled to the processor 810. The memory 820 stores instructions 822, 824, 826, 828, and 830 to cause the processor 810 to perform actions according to reference implementations of the present disclosure.

As shown in FIG. 8, the memory 820 stores instructions 822 to receive a request for scanning on a second channel different from the first channel from a controller. The memory 820 further stores instructions 824 to determine, based on the request, a first duration for the scanning of the second channel. Moreover, the memory 820 further stores instructions 826 to determine, based on the first duration, a second duration for preventing a station from sending a packet to the AP on the first channel. The memory 820 further stores instructions 828 to generate, based on the second duration, a beacon frame or a probe response frame, including a quiet element or a traffic identifier (TID)-to-link mapping element. As shown in FIG. 8, the memory 820 further stores instructions 830 to transmit the beacon frame or the probe response frame to the station.

Program codes or instructions for carrying out methods of the present disclosure may be written in any combination of one or more programming languages. These program codes or instructions may be provided to a processor or controller of a general-purpose computer, special-purpose computer, or other programmable data processing apparatus, such that the program codes, when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine, or entirely on the remote machine or server.

Program codes or instructions for carrying out methods of the present disclosure may be written in any combination of one or more programming languages. These program codes or instructions may be provided to a processor or controller of a general-purpose computer, special-purpose computer, or other programmable data processing apparatus, such that the program codes, when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but is not limited to an electronic, magnetic, optical, electromagnetic, infrared, or semiconductor system, apparatus, device, or any suitable combination of the foregoing. More specific examples of the machine-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order or that all illustrated operations be performed to achieve desirable results. In certain circumstances, multitasking and parallel processing may be advantageous. Certain features that are described in the context of separate implementations may also be implemented in combination in a single implementation. Conversely, various features that are described in the context of a single implementation may also be implemented in multiple implementations separately or in any suitable sub-combination.

In the foregoing Detailed Description of the present disclosure, reference is made to the accompanying drawings that from a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

What is claimed:

1. A method comprising:
receiving, by an access point (AP) working on a first channel and from a controller, a request for scanning on a second channel different from the first channel;
determining, by the AP and based on the request, a first duration for the scanning of the second channel;
determining, by the AP and based on the first duration, a second duration for preventing a station from sending a packet to the AP on the first channel;
generating, by the AP and based on the second duration, a beacon frame or a probe response frame including a quiet element or a traffic identifier (TID)-to-link mapping element; and
transmitting, by the AP to the station, the beacon frame or the probe response frame.

2. The method according to claim 1, wherein the beacon frame or the probe response frame includes the quiet element, and determining the second duration comprises:
determining the first duration as the second duration.

3. The method according to claim 2, further comprising:
determining a number of target beacon transmission time (TBTT) intervals to be passed before the scanning; and
determining a switching duration from the first channel to the second channel.

4. The method according to claim 3, wherein generating the beacon frame or the probe response frame comprises:
filling a quiet count field in the quiet element based on the number of TBTT intervals;
filling a quiet offset field in the quiet element based on the switching duration; and
filling a quiet duration in the quiet element based on the second duration.

5. The method according to claim 4, where the AP is an AP multi-Link device (MLD), the beacon frame or the probe response frame is transmitted on a first link for the AP MLD, and the method further comprises:
setting, based on the quiet element, a second quiet element in a second beacon frame or a second probe response frame, the second quiet element being used to notify the scanning on the first link; and
transmitting the second beacon frame or the second probe response frame on a second link for the AP MLD.

6. The method according to claim 1, wherein the beacon frame or the probe response frame includes the TID-to-link mapping element, the AP is an AP multi-Link device (MLD), the scanning is performed on the first link for the AP MLD, and determining the second duration comprises:
determining the second duration based on the first duration and a switching duration from the first channel to the second channels on the first link.

7. The method according to claim 6, further comprising:
determining a time interval to be passed before preforming a TID-to-link mapping.

8. The method according to claim 7, wherein generating the beacon frame or the probe response frame comprises:
filling a mapping switch time field in the TID-to-link mapping element based on the time interval;
filling an expected duration field in the TID-to-link mapping element based on the second duration; and
filling a set of link mapping of TID fields in the TID-to-link mapping element to avoid mapping any TID to the first link.

9. The method according to claim 8, further comprising:
setting, based on the TID-to-link mapping element, a second TID-to-link mapping element in a second beacon frame or a second probe response frame, the second TID-to-link mapping element being used to notify the scanning on the first link; and
transmitting the second beacon frame or the second probe response frame on a second link for the AP MLD.

10. The method according to claim 1, further comprising:
performing a switching operation from the first channel to the second channel; and
performing the scanning on the second channel.

11. An access point (AP) comprising:
at least one processor;
a memory coupled to the at least one processor, the AP working on a first channel, the memory storing instructions to cause the at least one processor to:
receive a request for scanning on a second channel different from the first channel from a controller;
determine, based on the request, a first duration for the scanning of the second channel;
determine, based on the first duration, a second duration for preventing a station from sending a packet to the AP on the first channel;
generate, based on the second duration, a beacon frame or a probe response frame including a quiet element or a traffic identifier (TID)-to-link mapping element; and
transmit the beacon frame or the probe response frame to the station.

12. The AP according to claim 11, wherein the beacon frame or the probe response frame includes the quiet element, and the instructions to determine the second duration comprise instructions to cause the at least one processor to:
determine the first duration as the second duration.

13. The AP according to claim 12, the instructions further comprising instructions to cause the at least one processor to:
determine a number of target beacon transmission time (TBTT) intervals to be passed before the scanning; and
determine a switching duration from the first channel to the second channel.

14. The AP according to claim 13, wherein the instructions to generate the beacon frame or the probe response frame comprise instructions to cause the at least one processor to:
fill a quiet count field in the quiet element based on the number of TBTT intervals;
fill a quiet offset field in the quiet element based on the switching duration; and
fill a quiet duration in the quiet element based on the second duration.

15. The AP according to claim 14, where the AP is an AP multi-Link device (MLD), the beacon frame or the probe response frame is transmitted on a first link for the AP MLD, and the instructions further comprise instructions to cause the at least one processor to:
set, based on the quiet element, a second quiet element in a second beacon frame or a second probe response frame, the second quiet element being used to notify the scanning on the first link; and
transmit the second beacon frame or the second probe response frame on a second link for the AP MLD.

16. The AP according to claim 11, wherein the beacon frame or the probe response frame includes the TID-to-link mapping element, the AP is an AP multi-Link device (MLD), the scanning is performed on the first link for the AP MLD, and the instructions to determine the second duration comprise instructions to cause the at least one processor to:
determine the second duration based on the first duration and a switching duration from the first channel to the second channels on the first link.

17. The AP according to claim 16, the instructions further comprising instructions to cause the at least one processor to:
determine a time interval to be passed before preforming a TID-to-link mapping.

18. The AP according to claim 17, wherein the instructions to generate the beacon frame or the probe response frame comprise instructions to cause the at least one processor to:
fill a mapping switch time field in the TID-to-link mapping element based on the time interval;
fill an expected duration field in the TID-to-link mapping element based on the second duration; and
fill a set of link mapping of TID fields in the TID-to-link mapping element to avoid mapping any TID to the first link.

19. The AP according to claim 18, the instructions further comprising instructions to cause the at least one processor to:
set, based on the TID-to-link mapping element, a second TID-to-link mapping element in a second beacon frame or a second probe response frame, the second TID-to-link mapping element being used to notify the scanning on the first link; and
transmit the second beacon frame or the second probe response frame on a second link for the AP MLD.

20. A non-transitory computer-readable medium comprising instructions stored thereon which, when executed by an access point (AP) working on a first channel, cause the AP to:
receive a request for scanning on a second channel different from the first channel from a controller;
determine, based on the request, a first duration for the scanning of the second channel;
determine, based on the first duration, a second duration for preventing a station from sending a packet to the AP on the first channel;
generate, based on the second duration, a beacon frame or a probe response frame including a quiet element or a traffic identifier (TID)-to-link mapping element; and
transmit the beacon frame or the probe response frame to the station.
